(19) United States
(12) Patent Application Publication
(10) Pub. No.: US 2025/0391265 A1
(43) Pub. Date: Dec. 25, 2025

(54) Multi-Modality Environmental Monitoring Network

(71) Applicant: Rodney Keller, Wellington, FL (US)

(72) Inventor: Rodney Keller, Wellington, FL (US)

(21) Appl. No.: 18/752,693

(22) Filed: Jun. 24, 2024

(51) Int. Cl. G08B 31/00; G08B 25/10; G08B 29/18

(52) U.S. Cl. CPC G08B 31/00; G08B 25/10; G08B 29/188

(57) ABSTRACT

Environmental monitors, networks and methods of monitoring discrete environments are provided that include a plurality of sensors connected to a computer device that uses trained and trainable artificial intelligence, voice recognition, and sensor fusion capabilities to discern threats and dangers from non-threatening and non-dangerous occurrences in order to determine when to issue an alarm and other communications to users and others.

### FIELD OF THE INVENTION

The invention relates to environmental monitors comprised of multi-modality sensors organized in a network governed in part with artificial intelligence and methods for using such.

### BACKGROUND OF THE INVENTION

Current environmental monitors suffer from responding to threats poorly and after they occur. As just some examples, concerning fire detection, a fire with smoke must be started before the threat is detected. For fall detection, a person wears a device to alert help after the fall.

For home security, a burglar has to breach a door or window for the threat to be detected. Environmental monitors (e.g., home and corporate security, medical, fire) in the past place over reliance on limited sensors that are very limited and do not provide enhanced situational awareness for early threat detection and warning.

Monitors and methods of using them that detect and prevent threats and dangers earlier are needed to enhance safety and reduce loss.

### SUMMARY OF THE INVENTION

Certain embodiments of this invention provide a monitor or network comprised of sensors (e.g., detectors) that enhance threat prevention and detection in a variety of scenarios. In preferred embodiments, this network uses artificial intelligence to discriminate between normal (e.g., a gas stove, lighting a cigar, a pet, a person's normal morning routine) and abnormal events (e.g., threats and dangers) to provide threat prevention and early detection and communication with users. In preferred embodiments, the network also has speakers and voice recognition features and is connected to a mobile phone service provider with access to police, fire, healthcare, user and/or emergency contact personnel and devices.

In preferred embodiments, a monitor or network comprised of LiDAR, multi-spectral sensors in visible and infrared wavelengths, and acoustic sensors, among others, are arranged in an environment and are connected to a central processor (CPU) with artificial intelligence. Currently, personal artificial intelligence networks are available with limited capabilities that can converse with users and outside entities (e.g., Amazon Alexa can control lights and has contacts with UPS when deliveries are made) but they have not been applied to environmental monitoring like home and health safety and security.

This monitor or network provides a virtual 3D map of the environment. The network distinguishes between humans and animals, identifying known and unknown targets by facial recognition and body composition, and tracks the individual motion of multiple targets within the field of view of each sensor as they move about the environment. The system is capable of passing target data between and/or regarding sensors, effectively tracking a person moving between rooms and through passageways.

The artificial intelligence has been trained with scenarios similar to the given environment, and in preferred embodiments can be further trained in the specific environment it is being used in after it is installed. This includes the use of object, movement, facial, voice, and sound recognition artificial intelligence capabilities.

For example, the artificial intelligence component can be trained to take data from movement sensors to recognize cats and dogs from humans. When installed, any false alarms can be used to further train the artificial intelligence with the particular on site circumstances (e.g., presence of small children, presence and location of gas stove). As another example, the user can use role-play to produce expected threats and dangers (e.g., falling, non-responsiveness, pet movement, lighting cigar) to train the artificial intelligence.

As another example, through object recognition artificial intelligence, the monitor or network can monitor the position of doors, windows, and their associated locks to alert if something is left open or unlocked. The network can monitor if the stove or oven has been left on, if cooking operations are left unattended, or if candles and heaters are forgotten. Furthermore, artificial intelligence can interpret the thermal signature of sparks, flames and heat sources and determine whether the room is occupied by humans or animals, while also distinguishing the age of known occupants when assessing danger. The network can warn occupants of unattended fire risks and actual fire dangers well before any smoke alarm could register a threat. The network can then alert personnel and emergency response services if required and alert personnel to the location of every person in a building being monitored.

The monitor or network can monitor specific zones, such as a pool area, based on physical and artificially defined boundaries, and notify when that restricted area is breached by person or animal. The network can also monitor devices and smart home solutions by integrating with such devices and solutions with capabilities to interact with the IoT (internet of things). Such control can be set through the keyboard or other input into the computing device of this invention.

The principal inputs to the monitor or network in preferred embodiments are through the sensors (e.g., detectors and other similar devices) voice recognition (voice sensing (e.g., through microphones, sound sensors) and recognition capability in the computing device) and a keyboard and/or touchscreen input to the computing device.

The artificial intelligence used with the sensors can determine based on velocity and body posture when a fall scenario has occurred, interrogate the subject, and notify emergency response services if required or if the subject is unresponsive. The artificial intelligence can also monitor a person's vital health statistics, orientation, and daily routines and identify changes to such that might be of concern (e.g., a person not getting out of bed in the morning). Furthermore, artificial intelligence can interpret the thermal signature of sparks, flames, and heat sources and determine if the room is occupied by humans or animals, while also distinguishing the age of known occupants when assessing danger.

In preferred embodiments, the monitor or network can warn occupants of unattended fire risks or actual fire dangers well before a smoke alarm would register. The system can alert personnel and emergency response services if required and alert appropriate personnel to the location of every person in the building. The system can monitor the interaction between humans and determine when a possible domestic violence scenario has occurred. The system can monitor the interior and exterior of buildings and alert occupants of potentially dangerous people or animals in the exterior environment using a combination of artificial intelligence and sensor data. In preferred embodiments the network provides virtually total situational awareness and early-warning risk identification for home or office provided by collective sensor data and artificial intelligence.

In particularly preferred embodiments, environmental (i.e., a discrete area such as a building or portion of a building) monitors and monitoring networks are provided. The monitors and networks comprise: (a) plurality of sensors, each sensor connected wirelessly and/or wired to a computing device, the sensors comprising LiDAR sensors, temperature sensors, smoke sensors, acoustic sensors, and/or other sensors known to a person of skill in the art. The networks also comprise: (b) the computing device that comprises programmable media, instructions, data storage, a video monitor, and an input keyboard, wherein the instructions comprise artificial intelligence with instructions and training capability and voice recognition capability. The networks also comprise: (c) communication devices comprising at least one speaker, at least one microphone, at least one alarm, and a mobile phone connection; and (d) wherein the artificial intelligence applies sensor fusion capabilities comprising the providing of tracking and monitoring of humans and pets, discernment of the difference between a spark and a fire, and sign language communication.

In these monitor and network embodiments, the monitor and network may further comprise (e) the capability of the sensors and computing device to recognize sign language and process its meaning and an appropriate response (e.g., a simulated voice response for others to hear, a visual alarm, contacting the police, contacting an emergency contact) using the artificial intelligence, and (f) the capability of the computing device to communicate with additional networks (e.g., through the internet, through a mobile phone line) to form a “neighborhood watch”-like monitor of threats and dangers.

In other particularly preferred embodiments, methods of monitoring a discrete environment are provided. These methods comprise: (a) engaging a plurality of sensors that each produce a sensor signal in the discrete environment, each sensor connected wirelessly and/or wired to a computing device, the sensors comprising LiDAR sensors, temperature sensors, smoke sensors, and acoustic sensors. The methods also comprise: (b) transferring the sensor signals to the computing device, the computing device comprising programmable media, instructions, data storage, a video monitor, and an input keyboard, wherein the instructions comprise artificial intelligence with instructions and training capability and voice recognition capability, wherein the communication devices comprise at least one speaker, at least one microphone, at least one alarm, and a mobile phone connection, and wherein the artificial intelligence applies sensor fusion capabilities comprising the providing of tracking and monitoring of humans and pets, discernment of the difference between a spark and a fire, and sign language communication. The methods also comprise: (c) engaging an alarm in response to the computer device and output from the artificial intelligence. The alarm response can change as the artificial intelligence is trained to the particular needs of a specific discrete environment, such as artefacts from false alarms, and normal activities that are not threats or dangers (e.g., pet movement, lighting a cigar).

In these method embodiments, the methods may further comprise (d) recognizing sign language and processing its meaning with the sensors and computer device and providing an appropriate response (e.g., a simulated voice response for others to hear, a visual alarm, contacting the police, contacting an emergency contact) using the artificial intelligence, and (e) communicating (e.g., through the internet, through a mobile phone line) with additional networks with the computing device to form a “neighborhood watch”-like monitor of threats and dangers.

Advantages of the embodiments of this invention are described and apparent throughout this specification. For example, certain embodiments provide early threat prevention and detection. Further advantages will be apparent to a person of skill in the art applying the embodiments of the invention.

Additional features and advantages of various embodiments will be set forth in part in the description that follows, and in part will be apparent from the description, or may be learned by practice of various embodiments. The objectives and other advantages of various embodiments will be realized and attained by means of the elements and combinations particularly pointed out in the description and appended claims.

### DETAILED DESCRIPTION OF THE INVENTION

Environmental monitoring networks and methods of monitoring discrete environments are provided that comprise a plurality of sensors (e.g., detectors) connected to a computer device that uses trained and trainable artificial intelligence, voice recognition, and sensor fusion capabilities to discern threats and dangers from non-threatening and non-dangerous occurrences in order to determine when to issue an alarm and other communications to users and others (e.g., police, fire, emergency contacts).

In preferred embodiments of this invention, the networks are comprised of various combinations of wireless (e.g., Bluetooth, internet, private networks, antennas, mobile phone access) and wired (e.g., land line phone, wired sensors, networks) components.

The components can include various combinations of (1) sensors (e.g., motion, door/window, heat, fire, smoke, light, temperature, sound, glass breaking, gases (e.g., carbon monoxide, LiDAR), water), (2) computing devices (e.g., mobile phones and apps, tablets and other handheld devices, dedicated devices, see below also) with programmable media, instructions, input devices (e.g., keyboard via touchscreen or manual keyboard), a video monitor, and data storage, including artificial intelligence programming and training capabilities and voice recognition capabilities, that are connected to one another (see above), and (3) communication devices (e.g., video monitors/keyboards, speakers, connected to the voice recognition, microphones, alarms, automatic phoning to police, fire, users, emergency contacts, etc., additional keyboard for data and command entry, inputs to the computing devices). Additional components (e.g., battery backup) will be used and known to a person of skill in the art in particular applications (e.g., particular hardware installations, weather protection).

An important aspect of this invention is that it uses sensor fusion technology that uses data from different networked sensors to obtain a less uncertain view of the circumstances, which produces higher fidelity tracking and monitoring. Another important aspect of this invention is to discern the difference between sparks (e.g., a cigar lighter) and fire scenarios.

Still another important aspect of this invention is that it provides persistent monitoring of the environment without a person present. Remote access to the system over the internet and through mobile phone apps is also available. Another important aspect of this invention is that the sensors can be configured to permit sign language communication with the network, enhanced by the artificial intelligence evaluating what the sign language means.

In certain embodiments, the network in one location is able to connect with other networks in other locations. In particular applications, this connection can form “neighborhood watch”-like protection. Thus, the networks and methods of this invention can be paired with neighboring networks to expand the coverage area to a neighborhood, giving warning of suspicious persons or activity in the area to all connected properties.

The subject matter of this disclosure is now described with reference to the following example. This example is provided for the purpose of illustration only, and the subject matter is not limited to this example, but rather encompasses all variations which are evident as a result of the teaching provided herein.

### Example 1

As an example of a particular network, an embodiment of this invention is installed inside and outside a one bedroom house with a kitchen, living room, and bathroom, and one front door, one back door and four windows. Various sensors consistent with possible threats (e.g., fire, burglary, window breaking, door opening, falls, water leaks, LiDAR) are installed to provide full coverage of the house. A central computing device is installed in the bedroom. It has a CPU, connected monitor, programming, including artificial intelligence programming that has been trained, a keyboard for data and command entry, a USB data port, a mobile phone connection, and wireless and wired connections to the sensors spread throughout the house that provide full coverage of each area with input from the sensors (e.g., sensor signals). The areas of the house can be represented on the CPU video monitor along with the sensor signals.

The user of this network in this example has a cat and upon a alarm from the network, reviews the monitor connected to the CPU, which identifies the source of the alarm as movement detected in the living room. The user realizes from the monitor that the alarm is from the cat's movement and indicates to the network through the CPU and keyboard, that the alarm it gave was not a threat or a danger but instead it was due to the cat. The artificial intelligence programming then reviews data associated with the alarm, including the movement and size of the cat, and learns to identify the cat as not a threat and to not issue an alarm because of it. Similarly, the user lights a cigar and an alarm is issued from the network. The user then accesses the CPU from the keyboard and indicates that the alarm was due to a cigar lighting and not a threat or danger from fire. The artificial intelligence programming then reviews the data associated with the alarm, including the size and heat signature of the flame from the cigar lighting, and learns to identify the cigar lighting as not a threat and to not issue an alarm because of it. Other examples of the use of the network and training of the artificial intelligence will be known and understood to a person of skill in the art.

### Particular Applications to Computer Devices

The system applied to this invention may include a plurality of different computing device types. In general, a computing device type may be a computer system or computer server. The computing device may be described in the general context of computer system executable instructions, such as program modules, being executed by a computer system (described for example, below). In some embodiments, the computing device may be a cloud computing node (for example, in the role of a computer server) connected to a cloud computing network (not shown). The computing device may be practiced in distributed cloud computing environments where tasks are performed by remote processing devices that are linked through a communications network. In a distributed cloud computing environment, program modules may be located in both local and remote computer system storage media including memory storage devices. Mobile phones, tablets, laptop computers and desktop computers are other examples of the computing device.

The computing device may typically include a variety of computer system readable media. Such media could be chosen from any available media that is accessible by the computing device, including non-transitory, volatile and non-volatile media, removable and non-removable media. The system memory could include random access memory (RAM) and/or a cache memory. A storage system can be provided for reading from and writing to a non-removable, non-volatile magnetic media device. The system memory may include at least one program product having a set (e.g., at least one) of program modules that are configured to carry out the functions of embodiments of the invention. The program product/utility, having a set (at least one) of program modules, may be stored in the system memory. The program modules generally carry out the functions and/or methodologies of embodiments of the invention as described herein.

As will be appreciated by one skilled in the art, aspects of the disclosed invention may be embodied as a system, method or process, or computer program product. Accordingly, aspects of the disclosed invention may take the form of an entirely hardware embodiment, an entirely software embodiment (including firmware, resident software, micro-code, etc.) or an embodiment combining software and hardware aspects “system.” Furthermore, aspects of the disclosed invention may take the form in part of a computer program product embodied in one or more computer readable media having computer readable program code embodied thereon.

### OTHER EMBODIMENTS

Although the present invention has been described with reference to teaching, examples and preferred embodiments, one skilled in the art can easily ascertain its essential characteristics, and without departing from the spirit and scope thereof can make various changes and modifications of the invention to adapt it to various usages and conditions. Those skilled in the art will recognize or be able to ascertain using no more than routine experimentation, many equivalents to the specific embodiments of the invention described herein. Such equivalents are encompassed by the scope of the present invention.

What is claimed is:

1. A method of monitoring a discrete environment comprising:
a. engaging a plurality of sensors that each produce a sensor signal in the discrete environment, each sensor connected wirelessly and/or wired to a computing device, the sensors comprising LiDAR sensors, temperature sensors, smoke sensors, and acoustic sensors;
b. transferring the sensor signals to the computing device, the computing device comprising programmable media, instructions, data storage, a video monitor, an input keyboard, and connections with communication devices, wherein the instructions comprise artificial intelligence with instructions and training capability and voice recognition capability, wherein the communication devices comprise at least one speaker, at least one microphone, at least one alarm, and a mobile phone connection, and wherein the artificial intelligence applies sensor fusion capabilities comprising the providing of tracking and monitoring of humans and pets, discernment of the difference between a spark and a fire, and sign language communication; and
c. engaging an alarm in response to the computer device and output from the artificial intelligence.

2. The method of claim 1, further comprising recognizing sign language with the sensors and computing device and processing its meaning and an appropriate response using the artificial intelligence.

3. The method of claim 1, further comprising communicating with additional networks to form a “neighborhood watch”-like monitoring.

4. An environmental monitor, the monitor comprising:
a. a plurality of sensors, each sensor connected wirelessly and/or wired to a computing device, the sensors comprising LiDAR sensors, temperature sensors, smoke sensors, and acoustic sensors;
b. the computing device comprising programmable media, instructions, data storage, a video monitor, an input keyboard, and connections with communication devices, wherein the instructions comprise artificial intelligence with instructions and training capability and voice recognition capability;
c. the communication devices comprising at least one speaker, at least one microphone, at least one alarm, and a mobile phone connection; and
d, wherein the artificial intelligence applies sensor fusion capabilities comprising the providing of tracking and monitoring of humans and pets, discernment of the difference between a spark and a fire, and sign language communication.

5. The monitor of claim 4, further comprising the capability of the sensors and computing device to recognize sign language and process its meaning and an appropriate response using the artificial intelligence.

6. The monitor of claim 4, further comprising the capability of the computing device to communicate with additional networks to form a “neighborhood watch”-like monitor.

7. An environmental monitoring network comprising:
a. a plurality of sensors, each sensor connected wirelessly and/or wired to a computing device, the sensors comprising LiDAR sensors, temperature sensors, smoke sensors, and acoustic sensors;
b. the computing device comprising programmable media, instructions, data storage, a video monitor, an input keyboard, and connections with communication devices, wherein the instructions comprise artificial intelligence with instructions and training capability and voice recognition capability;
c. the communication devices comprising at least one speaker, at least one microphone, at least one alarm, and a mobile phone connection; and
d, wherein the artificial intelligence applies sensor fusion capabilities comprising the providing of tracking and monitoring of humans and pets, discernment of the difference between a spark and a fire, and sign language communication.

8. The network of claim 7, further comprising the capability of the sensors and computing device to recognize sign language and process its meaning and an appropriate response using the artificial intelligence.

9. The network of claim 7, further comprising the capability of the computing device to communicate with additional networks to form a “neighborhood watch”-like monitoring neighborhood network of individual networks.
